(19) United States
(12) Patent Application Publication
(10) Pub. No.: US 2020/0060266 A1
(43) Pub. Date: Feb. 27, 2020

(54) Use Of N-Alkyl Glucamides For Reducing Drift During The Application Of Glufosinate-Containing Plant Treatment Agents

(71) Applicant: Clariant International Ltd., Muttenz (CH)

(72) Inventors: Martin BAUER, Eppstein (DE); Peter BAUR, Schondorf (DE)

(73) Assignee: Clariant International Ltd., Muttenz (CH)

(21) Appl. No.: 16/611,798

(22) PCT Filed: May 9, 2018
(86) PCT No.: PCT/EP2018/062069

§ 371 Date: Nov. 7, 2019

(30) Foreign Application Priority Data
May 12, 2017 (DE) 10 2017 004 616.6

(51) Int. Cl. A01N 25/30; A01N 25/06; A01N 57/20; A01N 37/40

(52) U.S. Cl. CPC A01N 25/30; A01N 37/40; A01N 57/20; A01N 25/06

(57) ABSTRACT

The invention relates to the use of one or more N-alkyl glucamides of formula (I), wherein R1 represents a linear or branched alkyl group having 5 to 9 carbon atoms, and R2 represents an alkyl group having 1 to 3 carbon atoms, for reducing drift during the application of plant treatment agents that contain at least one glufosinate as the agrochemically active substance.

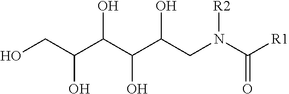

The invention relates to the use of particular N-alkylglucamides as drift-reducing components in glufosinate-containing crop-treatment compositions, to the use of particular N-alkylglucamides for reducing drift during application of said crop-treatment compositions, and to a method for reducing drift during application of said crop-treatment compositions.

Crop-protection compositions are applied to agricultural production fields in a very efficient manner using spray tanks in aircraft, tractors or other equipment. To maximize the accuracy of placement of the active ingredients, it is necessary for the spray cone to be as narrow as possible and to avoid drift of the spray mist away from the target area.

The drift of the spray mist is determined essentially by the droplet size distribution. The smaller the droplets, the longer the residence time in the air and the greater the tendency to drift horizontally and to evaporate and/or to miss the target area. It is known from the literature that the fine droplet fraction<150 μm (Teske et al., 2004, The Role of Small Droplets in Classifying Drop Size Distributions, ILASS Americas 17th Annual Conference, Arlington Va.), especially <100 μm (Vermeer et al., Proc. ISAA 2013, The use of adjuvanted formulations for drift control), determines the proportion of droplets in the spray mist that contributes to the drift effect. The reduction of the fine droplet fraction in the spray mist is therefore crucial to reduction of drift and is therefore utilized to determine the drift properties of a composition.

A distinct minimization of the drift effect can be achieved by adding, to crop-protection formulations, suitable drift-control agents that bring about a decrease in the fine droplet fraction and hence an increase in droplet size in the spray mist. Formulations modified with drift-control agents additionally need to be insensitive to the shear forces to which they are exposed in the spray pumps and nozzles. Good biodegradability, compatibility with other constituents of the crop-protection compositions, and high storage stability and thermal stability are further requirements for drift-control agents. It is known that the rheology of aqueous compositions can be modified by addition of water-soluble polymers, for example polyacrylamides, acrylamide/acrylic acid polymers, sodium polyacrylate, carboxymethyl cellulose, hydroxyethyl cellulose, methyl cellulose, polysaccharides, natural and synthetic guar gum (U.S. Pat. Nos. 4,413,087, 4,505,827, 5,874,096), which leads to a shift in the droplet size spectrum toward larger droplets.

Molasses and organic thickeners have also been described as effective agents for drift reduction (Pesticide Drift III; Drift Reduction with Spray Thickeners; Ware, G. W. et al.; J. of Economic Entomology 63; 1314-1316; 1970). It is additionally known that certain emulsions—via a mechanism that is not fully understood—lead to a reduced fine droplet content (Vermeer et al.; Crop Protection 44; 2013; Spray drift review: The extent to which a formulation can contribute to spray drift reduction).

Even though good results are already being achieved with the known systems, there are ongoing efforts, for technical, economic and ecological reasons, to find suitable drift-control agents that effectively increase the droplet volumes of the aqueous compositions and reduce drift of the spray mist under real-life conditions too.

Aqueous formulations of glufosinate ammonium are disclosed for example in EP-A-0048436, EP-A-0336151, EP-A-1093722 or WO 2007/147500 A1. Alkyl ether sulfates are preferably used here. Commercially available formulations use alkyl ether sulfates having a C₁₂ to C₁₆ alkyl chain length and containing 1 to 10 ethyleneoxy units as adjuvants. These are useful for boosting the biological effect of glufosinate when applied to the green parts of plants. The exact mechanism of action of alkyl ether sulfates here is unknown. The exceptional suitability of alkyl ether sulfates in boosting the effect of glufosinate derives from a combination of favorable properties of alkyl ether sulfates. Other adjuvants having comparable surfactant properties (for example adherence of spray mist or spread on target plants), including all adjuvants for herbicides described in the “Compendium of Herbicide Adjuvants” (www.herbicide-adjuvants.com, 2014), result in a weaker effect compared to said alkyl ether sulfates. Substances with solvent character, such as polyether glycols, glycerol, mineral oils, mineral oil concentrates, polymers, buffers, and other substances, are likewise not characterized by a comparable effect. The sole nonionic surfactants that are used in commercial formulations (Liberty®, from Bayer, EPA Reg. No. 264-829) are sugar-based alkyl polyglycosides. However, in order to avoid reducing the effect of the glufosinate formulation, these are used only in combination with the abovementioned alkyl ether sulfates.

After dilution of the formulation with water and application as a spray mixture, the C₁₂ to C₁₆ alkyl ether sulfates of the stated type that are typically present in commercially-available glufosinate formulations and the sugar-based alkyl polyglycosides optionally additionally present result in the generation of a high proportion of fine droplets that may be borne beyond the area to be treated and thus make spraying less effective or even harmful to adjoining areas and crops.

It has now surprisingly been found that particular N-alkyl-glucamides are suitable as drift-reducing adjuvants in glufosinate-containing crop-treatment compositions and bring about an effective increase in droplet size through a reduction in the fine droplet content in the spray mist on spraying of these crop-treatment compositions.

The use of N-alkylglucamides as surfactants in crop-treatment compositions is known.

WO 2016/050782 A1 describes glufosinate and selected N-alkylglucamide-containing aqueous adjuvant compositions.

WO 2014/067663 A1 discloses aqueous adjuvant compositions containing selected N-alkylglucamides. Suitability of N-alkylglucamides for drift reduction is not mentioned in these documents.

The invention provides for the use of one or more N-alkylglucamides of the formula (I)

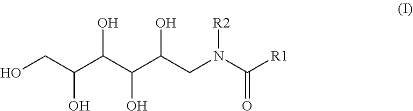

where
R1 is a linear or branched alkyl group having 5 to 9 carbon atoms and
R2 is an alkyl group having 1 to 3 carbon atoms,
for reducing drift during application of crop-treatment compositions comprising at least glufosinate as agrochemical active ingredient.

“Drift” in the context of the invention is understood as meaning the effect, during spraying of the crop-treatment composition, of forming small droplets that may be borne beyond the area to be treated, making spraying less effective or even harmful to adjoining areas and crops.

In addition to drift, smaller droplets have a tendency to increased vaporization, which can result in reduced availability of the active ingredient in the target area.

In the context of the present invention, the term “drift reduction” or “reduction of drift” is understood as meaning preferably the reduction, when applying glufosinate-containing spray mixtures that comprise N-alkylglucamides of the formula (I), of the proportion of fine droplets having a diameter<105 μm in the spray mist preferably by at least 10% and particularly preferably by at least 25% compared to the application of glufosinate-containing spray mixtures that, instead of N-alkylglucamides of the formula (I), contain alkyl ether sulfates having a C₁₂ to C₁₆ alkyl chain length and containing 1 to 10 ethyleneoxy units, optionally in combination with sugar-based polyglycosides (for example the formulation Liberty® from Bayer).

“Application” of a crop-treatment composition in the context of the invention is understood as meaning the application of an aqueous spray mixture comprising at least glufosinate as agrochemical active ingredient, and optionally further agrochemical substances, to the plants to be treated and/or the site thereof.

Preference is given to the use of crop-treatment compositions that comprise glufosinate as agrochemical active ingredient. Particular preference is given to the use of the agrochemical active ingredient glufosinate in the form of a water-soluble salt, particularly in the form of an optionally substituted ammonium salt (such as an ammonium, dimethylammonium, diglycolammonium, N,N-bis(3-aminopropyl)methylammonium, dimethylglucammonium, isopropylammonium or triethylammonium salt) or choline salt, most preferably in the form of a glufosinate ammonium salt.

In addition to the one agrochemical active ingredient glufosinate, the crop-treatment compositions used according to the invention may comprise at least one further agrochemical active ingredient. These are preferably agrochemical active ingredients selected from the group consisting of pesticides, phytohormones, preferably growth regulators, biological pest-control agents, fungicidal copper compounds, and/or repellents.

If this description mentions compounds as being water-soluble, this is understood as meaning compounds that at 25° C. dissolve to at least 50 g/l in water.

Glufosinate is preferably used in combination with further water-soluble agrochemical active ingredients. Particularly preferred as further water-soluble agrochemical active ingredients are pesticides, especially water-soluble salts of pesticides, and most preferably herbicides, especially water-soluble salts of herbicides.

In a further preferred embodiment, the further water-soluble pesticides are not herbicides but insecticides, preferably from the group of chloronicotinyls, such as thiamethoxam, or growth regulators, such as chlormequat chloride.

Water-soluble pesticides that are particularly preferably used in combination with glufosinate are water-soluble herbicides, with preference in turn given to water-soluble salts of acifluorfen, aminopyralid, amitrol, asulam, benazolin, bentazon, bialaphos, bispyribac, bromacil, bromoxynil, bicyclopyrone, chloramben, clopyralid, 2,4-D, 2,4-DB, dicamba, dichlorprop, difenzoquat, diquat, endothal, fenoxaprop, flamprop, flumiclorac, fluoroglycofen, fomesafen, fosamine, glyphosate, imazameth, imazamethabenz, imazamox, imazapic, imazapyr, imazaquin, imazethapyr, MCPA, MCPB, mecoprop, octanoic acid, paraquat, pelargonic acid, picloram, quizalofop, 2,3,6-TBA, and triclopyr.

The water-soluble salts of other agrochemical active ingredients, and of pesticides in particular, include in particular the alkali metal and ammonium salts, of which the potassium, ammonium, dimethylammonium, isopropylammonium, diglycolammonium, and (2-hydroxyethyl)trimethylammonium salts are in turn preferred.

The exact chemical composition and structures of all these compounds are known and available on the Internet at: http://www.alanwood.net/pesticides/index_cn_frame.html

The crop-treatment compositions most preferably used according to the invention are those in which glufosinate ammonium is used in combination with at least one water-soluble salt of dicamba, preferably in combination with dicamba diglycolammonium, dimethylammonium, N,N-bis(3-aminopropyl)methylammonium, dimethylglucammonium, and/or sodium dicamba.

With the above-described alkylglucamides of the formula (I), it is possible to prepare crop-treatment compositions used according to the invention, in particular aqueous herbicidal formulations, having excellent applications properties.

In the one or more alkylglucamides of the formula (I), the radical R1 is preferably a linear or branched alkyl group having 7 to 9 carbon atoms. The radical R2 is preferably a methyl group.

Particularly preferably, the crop-treatment compositions used according to the invention contain a mixture of octanoyl-N-methylglucamide (R1=C₇ alkyl, R2=methyl) and decanoyl-N-methylglucamide (R1=C₉ alkyl, R2=methyl). The proportion of octanoyl-N-methylglucamide in this mixture is 10% to 90% by weight, preferably 20% to 80% by weight, and particularly preferably 30% to 70% by weight, based on the total amount of N-alkylglucamides present in this mixture. The proportion of decanoyl-N-methylglucamide in this mixture is 10% to 90% by weight, preferably 20% to 80% by weight, and particularly preferably 30% to 70% by weight, based on the total amount of alkylglucamides present in this mixture.

The pentahydroxyhexyl radical in the N-alkylglucamides of the formula (I) has various chiral centers, which means that several stereoisomers may in each case exist. The N-alkylglucamides of the formula (I) are typically prepared from naturally occurring sugars, such as D-glucose, but the use of other natural or synthetic hexoses or other C₆ units is also possible in principle, which means that different stereoisomers of the formula (I) can result.

The N-alkylglucamides of the formula (I) are preferably based on renewable raw materials and are characterized by an advantageous toxicological and ecological profile. They have high solubility in water.

The preparation of N-alkylglucamides of the formula (I) has been described in sufficient detail in, for example, EP-A-550,637 and is known to those skilled in the art. It is achieved, for example, by condensation of carboxylic esters with a secondary N-alkylglucamine, which can in turn be prepared from a sugar such as D-glucose by reductive amination.

The N-alkylglucamides of the formula (I) are typically used in the form of solutions. For clarification, it should be mentioned here that the amounts given above are based on the active content in the solution of alkylglucamides of the formula (I).

For better handling, the N-alkylglucamides of the formula (I) are normally used in the form of aqueous solutions containing 10 to 90% by weight, more preferably 20 to 80% by weight, and particularly preferably 30 to 70% by weight of the one or more N-alkylglucamides of the formula (I). As a consequence of the manufacturing process, these adjuvant compositions may additionally contain one or more cosolvents as a secondary component. For clarification, it should be mentioned here that the amounts given above are based on the active content in the solution of N-alkylglucamides of the formula (I).

The crop-treatment compositions used according to the invention preferably contain one or more dihydric or trihydric alcohols as cosolvents. The one or more cosolvents may either be present as a secondary component from the manufacturing process of the N-alkylglucamide and/or have been added subsequently to the composition. The one or more co-solvents comprise a single dihydric or trihydric alcohol or a mixture of two or more such alcohols.

In the case of single-phase aqueous-organic solutions, the completely or largely water-miscible dihydric or trihydric alcohols or alcohol mixtures are suitable.

Suitable cosolvents are dihydric or trihydric alcohols, such as ethylene glycol, diethylene glycol, propylene glycol, glycerol or polyglycols, such as polyethylene glycol, polypropylene glycol or mixed polyalkylene glycols (PAGs), and most preferably glycerol, propylene glycol, and dipropylene glycol.

The proportion of cosolvent(s) in the crop-treatment composition used according to the invention in the form of concentrates is typically up to 30% by weight, preferably 1 to 25% by weight, and particularly preferably 2 to 20% by weight. The amounts given here are based on the total weight of the composition. The amounts of cosolvent may of course be correspondingly lowered by dilution prior to application.

It has been surprisingly found that the effectiveness of drift reduction in the crop-treatment composition used according to the invention is not lowered by the presence of polyalkylene glycol ether sulfate salts or of polyalkylene glycol ether sulfonate salts. This is in contrast to crop-treatment compositions containing alkyl ether sulfates having a C₁₂ to C₁₆ alkyl chain length and containing 1 to 10 ethyleneoxy units.

The invention therefore preferably relates to the use of one or more N-alkylglucamides of the formula (I) described above for reducing drift during application of crop-treatment compositions comprising
a) at least glufosinate as agrochemical active ingredient and optionally at least one further agrochemical active ingredient,
(b) one or more N-alkylglucamides of the above-described formula (I),
c) one or more polyalkylene glycol ether sulfate salts or polyalkylene glycol ether sulfonate salts,
d) water,
e) optionally one or more cosolvents selected from the group consisting of dihydric and trihydric alcohols, and
f) optionally further surfactants.

Components a), b), and e) of the crop-treatment composition used according to the invention have already been described above.

Component c) of the crop-treatment composition used according to the invention is a sulfated polyalkylene glycol. Surfactants of this type may contain one or more sulfate groups and/or sulfonate groups per molecule. These surfactants preferably contain one or more sulfate groups.

Particularly preferred surfactants of this type have the following structure:

(HO—(CH₂—CH₂—O—)ₙ(CH₂—CH(CH₃)—O)ₘ—CH₂—CH₂—O—SO₂—O⁻)_{q}M^{q+},

where
n and m are independently integers from 2 to 40,
q is 1 or 2, and
M is a mono- or divalent cation.

Typically, the surfactants of component c) contain repeat structural units having two to four carbon atoms, i.e. units derived from ethylene oxide, from propylene oxide, and/or from butylene oxide. Surfactants in component c) preferably contain ethylene oxide units and/or propylene oxide units. These may be randomly distributed in the molecule or present in the form of blocks.

The surfactants in component c) preferably contain an average of one sulfate group per molecule. The surfactants in component c) generally occur as a mixture of oligomers or of polymers having a different degree of polymerization or different molecular weight. Typical degrees of polymerization are in the range from 5 to 80, preferably from 5 to 60, and particularly preferably from 10 to 40 repeat units per molecule.

The compositions used are particularly preferably ones in which component c) contains ethylene oxide units, propylene oxide units, and/or butylene oxide units, especially ethylene oxide units and propylene oxide units.

The compositions used are most preferably ones in which component c) contains blocks of ethylene oxide units and of propylene oxide units.

The counterions of the sulfate group(s) or sulfonate group(s) of component c) may be freely chosen. The counterions are typically mono- to trivalent cations, especially mono- to divalent cations.

Preference is given to the use of components c) in which the polyalkylene glycol ether sulfate salt is an alkali metal, alkaline earth metal, sulfonium, triethylammonium, diglycolammonium, and/or ammonium salt, in particular an ammonium salt, a triethylammonium salt, a diglycolammonium salt, a sulfonium salt, a sodium salt or a potassium salt and most preferably an ammonium salt, a triethanolammonium salt, a diglycolammonium salt or a potassium salt.

Suitable as further surfactants (component f)) are anion-active, nonionogenic, cation-active, and/or zwitterionic surfactants. Examples of such surfactants are listed below (where, in each case, EO=ethylene oxide units, PO=propylene oxide units, and BO=butylene oxide units in terms of their preparation, or corresponding alkyleneoxy units in the surfactant molecules).

The surfactants in component f) may be a single surfactant or a mixture of two or more surfactants. The surfactants in component f) may generally be any nonionic, amphoteric, cationic or anionic surfactants that are compatible with the composition and are not surfactants present in component b) or in component c).

Examples of nonionic surfactants are EO/PO block copolymers (EO: ethyleneoxy unit; PO: propyleneoxy unit), alkoxylates, for example ethoxylates, of relatively long-chain aliphatic alcohols (e.g. alkoxylates and especially ethoxylates of linear or branched C₈ to C₂₄ alcohols) or of aromatic alcohols (e.g. alkylphenol alkoxylates, for example alkylphenol ethoxylates, tristyrylphenol alkoxylates, for example tristyrylphenol ethoxylates and tri-sec-butylphenol ethoxylates), castor oil ethoxylates, esters of long-chain carboxylic acids with mono- or polyhydric alcohols and the ethoxylation products thereof, optionally ethoxylated sorbitan esters, alkyl polyglycosides, fatty amine ethoxylates, relatively long-chain ether amine alkoxylates, and glucamides. Examples of suitable amphoteric surfactants are long-chain alkyldimethyl betaines, alkyldimethylamine oxides or alkyldimethylamine amidopropylamine oxides. Examples of suitable anionic surfactants include ether sulfates of ethoxylated fatty alcohols, reaction products of (optionally ethoxylated) long-chain alcohols with phosphoric acid derivatives, salts of dodecylbenzenesulfonic acid, and sulfosuccinates. “Long-chain” is understood as meaning linear or branched hydrocarbon chains having at least 6 and not more than 22 carbon atoms.

A preferred embodiment of the invention is the use of the one or more N-alkylglucamides of the formula (I) as an in-can variant for reducing drift during application of crop-treatment compositions containing glufosinate as agrochemical active ingredient. In this embodiment, the N-alkylglucamides of the formula (I) are already incorporated together with the constituents of the crop-treatment composition into a concentrated formulation and applied as a spray mixture after dilution with water.

The use according to the invention of the one or more N-alkylglucamides of the formula (I) or of a composition comprising one or more N-alkylglucamides of the formula (I) is preferably effected in ready-to-use glufosinate-containing crop-treatment compositions in the form of spray mixtures.

Examples of customary formulation types for crop-treatment compositions used according to the invention are water-soluble liquids (SL), emulsifiable concentrates (EC), emulsions in water (EW), suspension concentrates (SC, SE, FS, OD), water-dispersible granules (WG), granules (GR), and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576.

The crop-treatment compositions may optionally comprise effect-boosting adjuvants. An adjuvant in this context is a component that boosts the biological effect of the formulation, without the component itself having any biological effect. Examples of adjuvants are penetrants, for example vegetable oils such as rapeseed oil, sunflower oil, mineral oils such as liquid paraffins, alkyl esters of vegetable fatty acids such as rapeseed oil methyl ester, soy bean oil methyl ester or alkanol alkoxylates, and/or spreaders, for example alkylsiloxanes and/or salts such as organic or inorganic ammonium or phosphonium salts, for example ammonium sulfate or diammonium hydrogen phosphate, and/or retention promoters, for example dioctyl sulfosuccinate or hydroxypropyl guar polymers, and/or humectants, for example glycerol, and/or fertilizers such as ammonium-, potassium- or phosphorus-containing fertilizers, and/or agents that promote adherence to the leaf surface.

The crop-treatment compositions used according to the invention may optionally comprise auxiliaries, preferably in combination with the abovementioned components. Examples of such auxiliaries include extenders, solvents, spontaneity promoters, vehicles, emulsifiers, dispersants, antifreezes, biocides, and/or thickeners.

The crop-treatment compositions used according to the invention are produced in a known manner, for example by mixing the active ingredients with auxiliaries, for example extenders, solvents and/or solid vehicles and/or further auxiliaries, for example surfactants. The preparation of the crop-treatment compositions as formulations is carried out either in suitable facilities or else before or during application.

Auxiliaries used may be substances that are suitable for imparting particular properties to the formulation of the active ingredient or to the use forms prepared from these formulations (for example ready-to-use crop-protection compositions such as spray mixtures), such as particular physical, technical, and/or biological properties.

Examples of suitable extenders include water and polar and nonpolar organic chemical liquids, as already described above.

It is also possible to use liquefied gaseous extenders or solvents. Especially suitable are extenders or vehicles that are gaseous at standard temperature and under standard pressure, for example aerosol propellants such as halohydrocarbons and also butane, propane, nitrogen, and carbon dioxide.

Examples of emulsifiers and/or foam formers, dispersants or wetting agents with ionic or nonionic properties, or mixtures of such surface-active substances, are salts of polyacrylic acid, salts of lignosulfonic acid, salts of phenolsulfonic acid or naphthalenesulfonic acid, polycondensates of ethylene oxide with fatty alcohols or with fatty acids or with fatty amines, with substituted phenols (preferably alkylphenols or arylphenols), salts of sulfosuccinic esters, taurine derivatives (preferably alkyl taurates), phosphoric esters of polyethoxylated alcohols or phenols, fatty acid esters of polyols, and derivatives of the compounds containing sulfates, sulfonates, and phosphates, for example alkylaryl polyglycol ethers, alkyl sulfonates, alkyl sulfates, aryl sulfonates, protein hydrolyzates, lignin-sulfite waste mixtures, and methyl cellulose. The presence of a surface-active substance is advantageous when one of the active ingredients and/or one of the inert vehicles is insoluble in water and when application is effected in water.

Further auxiliaries that may be present in the formulations and in the use forms derived therefrom are colorants such as inorganic pigments, for example iron oxide, titanium oxide, and Prussian blue, and organic dyes such as alizarin dyes, azo dyes, and metal phthalocyanine dyes, and nutrients and trace nutrients such as salts of iron, manganese, boron, copper, cobalt, molybdenum, and zinc.

Additional components may be stabilizers, such as cold stabilizers, preservatives, antioxidants, light stabilizers, or other agents that improve chemical and/or physical stability. Foam generators or defoamers may additionally be present.

In addition, the formulations and use forms derived therefrom may also contain, as additional auxiliaries, stickers such as carboxymethyl cellulose, natural and synthetic polymers in powder, granule or latex form, such as gum arabic, polyvinyl alcohol, and polyvinyl acetate, and also natural phospholipids such as cephalins and lecithins, and synthetic phospholipids. Possible further auxiliaries are mineral and vegetable oils.

The formulations and the use forms derived therefrom may optionally contain further auxiliaries still. Examples of such additives are fragrances, protective colloids, binders, adhesives, thickeners, thixotropic agents, penetrants, retention promoters, stabilizers, sequestrants, complexing agents, humectants, spreaders.

In general, the agrochemical substances may be combined with any solid or liquid additive that is commonly used for formulation purposes.

Suitable retention promoters include all substances that reduce dynamic surface tension, for example dioctyl sulfosuccinate, or increase viscoelasticity, for example hydroxypropyl guar polymers.

Suitable penetrants in the present context are all substances that are typically used to improve the penetration of agrochemical substances into plants.

Penetrants are defined in this context by their ability to penetrate from the (generally aqueous) application mixture and/or from the spray coating into the cuticle of the plant and hence increase the mobility of the active ingredients in the cuticle. The method described in the literature (Baur et al., 1997, Pesticide Science 51, 131-152) can be used in the determination of this property. Examples include alcohol alkoxylates, for example coconut fat ethoxylate (10) or isotridecyl ethoxylate (12), fatty acid esters, for example rapeseed oil methyl ester or soy bean oil methyl ester, fatty amine alkoxylates, for example tallow amine ethoxylate (15) or ammonium salts and/or phosphonium salts, for example ammonium sulfate or diammonium hydrogen phosphate.

The production of the crop-treatment compositions used according to the invention is possible in various ways, according to formulation type, that are sufficiently well known to those skilled in the art. The procedure used in production may, for example, be to mix the N-alkylglucamides of the formula (I) with one or more agrochemical substances and optionally with auxiliaries. The order in which the components are mixed with one another is immaterial. Suitable production equipment is equipment typically used for production of agrochemical formulations.

For use according to the invention, crop-treatment compositions are typically employed in the form of spray mixtures. This involves production of a spray mixture preferably by dilution of a concentrate formulation with a defined amount of water.

Moreover, in order to achieve a satisfactory reduction in drift, it has been found that selected amounts of the N-alkylglucamide of the formula (I) and optionally further surfactants need to be present in the aqueous spray mixture. If the proportion of N-alkylglucamide of the formula (I) and optionally further surfactants is too high, the proportion of fine droplets formed will be too high, which has a disadvantageous effect on drift reduction. If, on the other hand, the proportion of N-alkylglucamide of the formula (I) and optionally further surfactants present is too low, its influence on the lowering of surface tension in the spray mixture will be too low, which adversely affects the wetting of the plant, retention, and biological activity.

The effect of drift reduction in aqueous spray mixtures has been found to be particularly pronounced when the total surfactant content, based on the total amount of spray mixture, is 0.001 to 0.3% by weight, with the proportion of N-alkylglucamide of the formula (I) amounting to 50 to 100% by weight based on the total amount of surfactant in the spray mixture.

Surfactant components are often used in the form of solutions or dispersions in water. The total percent surfactant contents in this description are based on 100% active content unless otherwise specified.

Such spray mixtures may be produced preferably using concentrates that have a total surfactant content, based on the total amount of concentrate, of 0.1 to 30% by weight, with the proportion of N-alkylglucamide of the formula (I) amounting to 50 to 100% by weight based on the total amount of surfactant in the concentrate.

The invention therefore also relates to a method for reducing drift during application of a crop-treatment composition, which comprises spraying an aqueous spray mixture comprising one or more N-alkylglucamides of the formula (I), at least glufosinate as agrochemical active ingredient, and optionally further surfactants onto the plants to be treated or the site thereof, wherein the total surfactant content, based on the total amount of aqueous spray mixture, is 0.001 to 0.30% by weight, preferably 0.01 to 0.25% by weight, and wherein the proportion of N-alkylglucamide of the formula (I), based on the total amount of surfactant in the aqueous spray mixture, amounts to 50 to 100% by weight.

The invention further relates to a method for preparing an aqueous spray mixture having drift-reducing properties when applied, which comprises diluting a concentrate comprising one or more N-alkylglucamides of the formula (I), at least glufosinate as agrochemical active ingredient, and optionally further surfactants with water to give an aqueous spray mixture, wherein the total surfactant content of the concentrate, based on the total amount of concentrate, is 0.1 to 30% by weight, preferably 1 to 25% by weight, the proportion of N-alkylglucamide of the formula (I), based on the total amount of surfactant in the concentrate, amounts to 50 to 100% by weight, and wherein the total surfactant content of the aqueous spray mixture, based on the total amount of aqueous spray mixture, is 0.001 to 0.30% by weight, preferably 0.01 to 0.25% by weight, and the proportion of N-alkylglucamide of the formula (I), based on the total amount of surfactant in the aqueous spray mixture, amounts to 50 to 100% by weight.

The compositions used according to the invention in the form of concentrates preferably contain 1 to 40% by weight, more preferably 10 to 35% by weight, particularly preferably 15 to 30% by weight of the agrochemical active ingredient glufosinate. The amounts given here are based on the total weight of the composition. The amounts of glufosinate and optionally further agrochemical active ingredients used therewith may of course be appropriately lowered by dilution prior to application.

The compositions used according to the invention in the form of concentrates preferably contain 1 to 40% by weight, more preferably 2 to 30% by weight, particularly preferably 5 to 20% by weight of the one or more further agrochemical active ingredients. The amounts given here are based on the total weight of the composition. The amounts of the further agrochemical active ingredients may of course be appropriately lowered by dilution prior to application.

The invention further relates to a method for reducing drift during application of a crop-treatment composition and comprising the above-described components a), b), c), and d) and optionally e) and/or f), which comprises spraying the crop-treatment composition in the form of an aqueous spray mixture onto the plants to be treated or the site thereof,

The content of agrochemical active ingredients in the crop-treatment compositions used according to the invention may vary within wide ranges. The concentration of the agrochemical active ingredients in the use forms, particularly in the spray mixtures, may typically be between 0.000001% and 10% by weight of agrochemical active ingredient, preferably between 0.00001% and 5% by weight of agrochemical active ingredient, more preferably between 0.0001% and 1% by weight of agrochemical active ingredient, and particularly preferably between 0.001% and 1% by weight of agrochemical active ingredient, based on the weight of the use form, particularly of the spray mixture. Application is accomplished in a customary manner appropriate to the use forms.

### EXAMPLES

The invention is illustrated hereinafter by examples, but these should not be regarded as in any way restrictive.

The percentages stated hereinafter are percentages by weight (% by weight), unless explicitly stated otherwise.

The raw materials used are:
Glufosinate ammonium Glufosinate ammonium salt (98% by weight active), from Schirm
Dicamba Dicamba acid (98% by weight active), from Schirm
DGA Diglycolamine, from Huntsman
Genapol LRO paste Lauryl ether sulfate (68% by weight active), from Clariant
Synergen GA C8/10 glucamide (50% by weight active), from Clariant
Synergen PFA Polyalkylene ether sulfate ammonium (50% by weight active), from Clariant
AMS Ammonium sulfate, from Redox
Propylene glycol 1,2-Propylene glycol, from Clariant
Dipropylene glycol Dipropylene glycol, from Merck
Glycerol Glycerol, from Merck
1-Methoxy-2-propanol 1-Methoxy-2-propanol, from Alfa Aesar
Diammonium hydrogen citrate Diammonium hydrogen citrate, from Merck
Defoamer Silicone-based defoamer from Momentive
Water Deionized water or tap water
Liberty® Glufosinate ammonium SL formulation (280 gift from Bayer

### Example 1: Aqueous Glufosinate Formulations (Glufosinate Ammonium 200-350 g/l a.e.)

The glufosinate ammonium preparations A1-A11 listed in Table 1 were produced by mixing the various components with water. The preparations were then stored for 8 weeks at −10° C., 0° C., 25° C. (room temperature) and for 2 weeks at 54° C. to determine their storage stability and phase behavior.

TABLE 1
Composition of aqueous glufosinate formulations (glufosinate ammonium 200-350 g/l a.i.) in % by weight

| | Glufosinate concentration (g/l) | | | | | | | | | | |
|---|---|---|---|---|---|---|---|---|---|---|---|
| | 280 | | | | | | | | | | |
| | A1 | | | | | | | | | | |
| | (non- | 280 | 280 | 280 | 200 | 200 | 200 | 350 | 350 | 280 | 280 |
| Example | inventive) | A2 | A3 | A4 | A5 | A6 | A7 | A8 | A9 | A10 | A11 |
| Glufosinate | 24.8 | 25.1 | 24.9 | 24.9 | 18.0 | 17.5 | 17.1 | 30.2 | 30.4 | 24.9 | 24.9 |
| ammonium | | | | | | | | | | | |
| Genapol LRO | 25.0 | 0.0 | 0.0 | 0.0 | 0.0 | 0.0 | 0.0 | 0.0 | 0.0 | 0.0 | 0.0 |
| paste | | | | | | | | | | | |
| Synergen GA | 0.0 | 50.0 | 33.5 | 20.0 | 50.0 | 30.0 | 25.0 | 45.0 | 30.0 | 10.0 | 12.5 |
| Synergen PFA | 0.0 | 0.0 | 0.0 | 0.0 | 0.0 | 0.0 | 0.0 | 0.0 | 0.0 | 5.0 | 7.5 |
| Propylene | 0.0 | 10.0 | 10.0 | 0.0 | 10.0 | 10.0 | 0.0 | 10.0 | 10.0 | 0.0 | 0.0 |
| glycol | | | | | | | | | | | |
| Dipropylene | 10.0 | 0.0 | 0.0 | 0.0 | 0.0 | 0.0 | 0.0 | 0.0 | 0.0 | 0.0 | 0.0 |
| glycol | | | | | | | | | | | |
| Glycerol | 0.0 | 0.0 | 0.0 | 10.0 | 0.0 | 0.0 | 10.0 | 0.0 | 0.0 | 10.0 | 10.0 |
| 1-Methoxy-2- | 5.0 | 1.0 | 2.0 | 2.0 | 0.0 | 0.0 | 0.0 | 1.0 | 1.0 | 0.0 | 0.0 |
| propanol | | | | | | | | | | | |
| Diammonium | 0.0 | 1.0 | 1.0 | 1.0 | 1.0 | 1.0 | 1.0 | 1.0 | 1.0 | 1.0 | 1.0 |
| hydrogen citrate | | | | | | | | | | | |
| Water | 35.1 | 12.8 | 23.6 | 32.1 | 21.0 | 36.5 | 36.9 | 12.7 | 22.5 | 49.1 | 44.1 |
| Ammonium | 0.0 | 0.0 | 5.0 | 10.0 | 0.0 | 5.0 | 10.0 | 0.0 | 5.0 | 0.0 | 0.0 |
| sulfate | | | | | | | | | | | |
| Momentive | 0.1 | 0.02 | 0.02 | 0.02 | 0.02 | 0.02 | 0.02 | 0.04 | 0.02 | 0.04 | 0.04 |
| SAG 1572 | | | | | | | | | | | |
| (defoamer) | | | | | | | | | | | |
| Appearance | homo- | homo- | homo- | homo- | homo- | homo- | homo- | homo- | homo- | homo- | homo- |
| at 54° C. | geneous | geneous | geneous | geneous | geneous | geneous | geneous | geneous | geneous | geneous | geneous |
| Appearance | homo- | homo- | homo- | homo- | homo- | homo- | homo- | homo- | homo- | homo- | homo- |
| at 25° C. | geneous | geneous | geneous | geneous | geneous | geneous | geneous | geneous | geneous | geneous | geneous |
| Appearance | homo- | homo- | homo- | homo- | homo- | homo- | homo- | homo- | homo- | homo- | homo- |
| at 0° C. | geneous | geneous | geneous | geneous | geneous | geneous | geneous | geneous | geneous | geneous | geneous |
| Appearance | homo- | frozen | homo- | frozen | frozen | frozen | frozen | frozen | frozen | frozen | frozen |
| at −10° C. | geneous | | geneous | | | | | | | | |

The compositions used according to the invention are homogeneous and phase-stable at 0° C., room temperature (25° C.), and 54° C. Some of the compositions used according to the invention solidify during storage at −10° C. for 8 weeks, but return to a homogeneous and phase-stable state at 0° C.

The compositions used according to the invention are homogeneous and phase-stable at −10° C., 0° C., room temperature (approx. 25° C.), and 54° C.

### Example 2: Aqueous Glufosinate-Dicamba Combination Formulations (200 g/l a.e. Glufosinate Ammonium and 200 g/l a.e. Dicamba DGA)

The glufosinate ammonium preparations B1-B3 listed in Table 2 were produced by mixing the various components with water. The preparations were then stored for 2 weeks at −10° C., 0° C., 25° C. (room temperature), and 54° C. to determine their storage stability and phase behavior.

TABLE 2
Composition of glufosinate-dicamba combination formulations
(200 g/l a.e. glufosinate ammonium and 200 g/l a.e. dicamba)

| | Glufosinate/Dicamba concentration (g/l) | | |
|---|---|---|---|
| | 200/200 | 200/200 | 200/200 |
| Example | B1 | B2 | B3 |
| Glufosinate | 17.0 | 17.0 | 18.9 |
| ammonium | | | |
| Dicamba | 16.6 | 16.6 | 17.2 |
| DGA | 8.1 | 8.1 | 8.1 |
| Synergen GA | 15.0 | 20.0 | 25.0 |
| Propylene glycol | 9.5 | 9.5 | 9.5 |
| 1-Methoxy-2-propanol | 2.0 | 2.0 | 2.0 |
| Diammonium | 1.0 | 1.0 | 1.0 |
| hydrogen citrate | | | |
| Water | 30.8 | 25.8 | 18.3 |
| Momentive SAG 1572 | 0.02 | 0.02 | 0.02 |
| (defoamer) | | | |
| Appearance at 54° C. | homogeneous | homogeneous | homogeneous |
| Appearance at 25° C. | homogeneous | homogeneous | homogeneous |
| Appearance at 0° C. | homogeneous | homogeneous | homogeneous |
| Appearance at −10° C. | homogeneous | homogeneous | homogeneous |

The compositions used according to the invention are homogeneous and phase-stable at −10° C., 0° C., room temperature (approx. 25° C.), and 54° C.

### Example 3: Preparation of the Spray Mixtures Containing Glufosinate Ammonium Formulations from Table 1 and 2

The composition of spray mixtures V1-V19 is specified in Table 3 below. These spray mixtures were produced by mixing the glufosinate formulations from Table 1 and 2, the commercial formulation Liberty as reference, and water. The total amount of surfactant in the spray mixture stated in Table 3 is based on the products used (Genapol® LRO, Synergen® GA, Synergen PFA) without taking account of the active content and calculated from the employed amount of “glufosinate formulation” x amount of surfactant in the formulation (see Tables 1 and 2).

TABLE 3

| | | Amount of glufosinate | Amount of surfactant |
|---|---|---|---|
| Spray | | in the formulation | in the spray mixture |
| mixture | Formulation | [% by weight] | [% by weight] |
| V1 | Liberty (non- | 0.89 | — |
| | inventive) | | |
| V2 | Liberty (non- | 1.43 | — |
| | inventive) | | |
| V3 | A1 (non- | 0.89 | 0.22 |
| | inventive) | | |
| V4 | A1 (non- | 1.43 | 0.36 |
| | inventive) | | |
| V5 | A2 | 1.20 | 0.60 |
| V6 | A3 | 1.20 | 0.40 |
| V7 | A4 | 1.20 | 0.24 |
| V8 | A5 | 1.66 | 0.83 |
| V9 | A6 | 1.66 | 0.50 |
| V10 | A7 | 1.66 | 0.42 |
| V11 | A8 | 1.00 | 0.45 |
| V12 | A9 | 1.00 | 0.30 |
| V13 | A10 | 1.00 | 0.15 |
| V14 | A10 | 1.60 | 0.24 |
| V15 | A11 | 1.00 | 0.20 |
| V16 | A11 | 1.60 | 0.32 |
| V17 | B1 | 1.60 | 0.24 |
| V18 | B2 | 1.60 | 0.32 |
| V19 | B3 | 1.60 | 0.40 |

### Example 4: Droplet Size Distribution of the Glufosinate Ammonium Formulations Used According to the Invention

### 4A: Measurement of Droplet Size Distribution

A Malvern Spraytec “real-time spray-sizing system” was used to determine the droplet size distribution. For this purpose, the system (STP5311, Malvern Instruments GmbH, Heidelberg, Germany) was installed in a specially constructed spray booth, with the option of being able to choose spray applications customary in practice with freely adjustable pressure for various hydraulic nozzles and freely adjustable distances (nozzle-target surface). The spray booth can be darkened and all interfering parameters can be eliminated. For the measurements, the standard flat-jet nozzle XR11002 (TeeJet) having a high proportion of fine droplets (<105 μm) in the droplet spectrum and injector nozzles ID(3)12002 (Lechler) having larger droplet sizes were used. The pressure set was varied, and mean pressure was kept constant at 3 bar for the measurements reported hereinafter. The temperature and relative air humidity varied between 21.5° C. and 29° C. and between 33% and 56% respectively.

The Spraytec measurement was performed at the setting of 1 kHz, since measurements at 2.5 kHz or higher and also other influencing variables such as additional suction were found to be negligible. The measurement in the spray cone was kept constant at a position having distances of exactly 29.3 cm from the nozzle and 0.4 cm from the perpendicular below the nozzle. The measurements were performed within 5 seconds and the mean of 6 replicate measurements is reported as the proportion by volume of droplets having diameters<90 μm (“Vol 90”), <105 μm (“Vol 105”), and <150 μm (“Vol 150”) (percentage standard error 0.5%-2.5%). As a further measurement parameter, the proportion by volume of droplets having diameter<210 μm (“Vol 210”) was determined and expressed in relation to the proportion by volume of droplets having diameter<105 μm (“Vol 210/Vol 105”). As a commercial benchmark, the test series included parallel measurements of spray mixtures containing the Liberty® glufosinate ammonium formulations from Bayer. In addition, the percentage reduction in the proportion by volume of droplets having diameter<105 μm was calculated for the use of spray mixtures containing the test substances versus the use of spray mixture V2 containing Liberty® commercial glufosinate ammonium formulations as internal standard (“Red 105”).

### 4B: Droplet Size Distribution for ID(3)12002 Injector Nozzle (at 3 Bar) Using Spray Mixtures V1-V19 (for Composition See Table 3).

TABLE 4

| Spray | | Vol 90 | Vol 105 | Vol 150 | Vol 210/ | Red 105 |
|---|---|---|---|---|---|---|
| liquid | Formulation | [% by vol.] | [% by vol.] | [% by vol.] | Vol 105 | [%] |
| V1 | Liberty (n.i.) | 5.01 | 7.99 | 19.20 | 4.35 | 5.06 |
| V2 | Liberty (n.i.) | 5.33 | 8.42 | 20.21 | 4.38 | 0.00 |
| V3 | A1 (n.i.) | 5.83 | 8.79 | 19.66 | 3.98 | −4.47 |
| V4 | A1 (n.i.) | 5.68 | 8.67 | 19.87 | 4.12 | −3.03 |
| V5 | A2 | 4.91 | 8.10 | 20.49 | 4.61 | 3.73 |
| V6 | A3 | 3.24 | 5.42 | 15.38 | 5.72 | 35.65 |
| V7 | A4 | 0.84 | 1.38 | 3.64 | 5.89 | 83.57 |
| V8 | A5 | 5.05 | 8.13 | 20.19 | 4.54 | 3.43 |
| V9 | A6 | 2.23 | 4.05 | 11.89 | 5.93 | 51.90 |
| V10 | A7 | 1.45 | 2.61 | 7.91 | 6.61 | 69.02 |
| V11 | A8 | 2.91 | 5.00 | 13.27 | 4.96 | 40.64 |
| V12 | A9 | 2.13 | 3.52 | 8.90 | 4.70 | 58.18 |
| V13 | A10 | 2.06 | 3.23 | 7.42 | 4.37 | 61.67 |
| V14 | A10 | 2.39 | 4.05 | 10.52 | 5.01 | 51.93 |
| V15 | A11 | 2.30 | 3.77 | 9.33 | 4.72 | 55.18 |
| V16 | A11 | 2.56 | 4.42 | 11.74 | 5.06 | 47.45 |
| V17 | B1 | 2.17 | 3.47 | 8.39 | 4.63 | 58.83 |
| V18 | B2 | 2.78 | 4.68 | 12.06 | 4.84 | 44.44 |
| V19 | B3 | 3.31 | 5.74 | 15.12 | 4.83 | 31.83 |

n.i. = non-inventive

### 4C: Droplet Size Distribution for TeeJet XR110-02 Flat-Jet Nozzle (at 3 Bar) Using Spray Mixtures V1-V19 (for Composition See Table 2).

TABLE 5

| Spray | | Vol 90 | Vol 105 | Vol 150 | Vol 210/ | Red 105 |
|---|---|---|---|---|---|---|
| liquid | Formulation | [% by vol.] | [% by vol.] | [% by vol.] | Vol 105 | [%] |
| V1 | Liberty (n.i.) | 27.37 | 37.66 | 64.40 | 2.25 | 1.87 |
| V2 | Liberty (n.i.) | 28.43 | 38.38 | 63.73 | 2.16 | 0.00 |
| V3 | A1 (n.i.) | 27.77 | 37.84 | 63.94 | 2.22 | 1.39 |
| V4 | A1 (n.i.) | 28.62 | 38.31 | 62.99 | 2.13 | 0.18 |
| V5 | A2 | 26.55 | 37.55 | 65.02 | 2.26 | 2.15 |
| V6 | A3 | 26.72 | 36.95 | 62.74 | 2.23 | 3.71 |
| V7 | A4 | 22.07 | 31.43 | 56.61 | 2.48 | 18.10 |
| V8 | A5 | 31.67 | 42.38 | 67.91 | 2.03 | −10.43 |
| V9 | A6 | 18.84 | 28.13 | 54.26 | 2.74 | 26.70 |
| V10 | A7 | 18.31 | 27.36 | 53.15 | 2.79 | 28.70 |
| V11 | A8 | 23.96 | 34.64 | 62.63 | 2.43 | 9.73 |
| V12 | A9 | 23.34 | 33.59 | 60.79 | 2.46 | 12.48 |
| V13 | A10 | 22.90 | 32.65 | 58.88 | 2.47 | 14.92 |
| V14 | A10 | 22.70 | 32.20 | 57.69 | 2.46 | 16.11 |
| V15 | A11 | 23.19 | 32.86 | 58.71 | 2.44 | 14.37 |
| V16 | A11 | 22.93 | 32.69 | 58.68 | 2.45 | 14.81 |
| V17 | B1 | 20.67 | 30.66 | 58.29 | 2.65 | 20.10 |
| V18 | B2 | 23.93 | 33.88 | 60.06 | 2.40 | 11.72 |
| V19 | B3 | 23.53 | 33.88 | 61.26 | 2.45 | 11.73 |

n.i. = non-inventive

### Example 5: Use of Glufosinate for Weed Control

The formulations A2 and A10 shown in Table 1 were diluted with water so as to achieve a water application rate of 120-400 I/ha at a typical application rate for glufosinate (300-1000 g/ha) when applied to uncultivated land having a range of monocotyledonous and dicotyledonous harmful plants that had grown under natural conditions. An evaluation of the effect after 4 weeks showed that the green parts of the harmful plants had died off, demonstrating that good control of the harmful plants had been achieved. For example, in terms of biological effect in the control of monocotyledonous and dicotyledonous harmful plants, formulations A2 and A10 from Table 1 showed comparably good results versus the commercially available formulation Liberty®, for the same application rate of glufosinate.

1. A method for reducing drift during application of a crop-treatment composition comprising at least glufosinate as agrochemical active ingredient, comprising the step of adding at least one alkylglucamide of the formula (I) 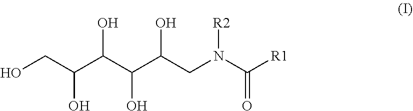
where
R1 is a linear or branched alkyl group having 5 to 9 carbon atoms and
R2 is an alkyl group having 1 to 3 carbon atoms,
to the crop-treatment composition comprising at least glufosinate as agrochemical active ingredient.

2. The method as claimed in claim 1, wherein the crop-treatment composition comprises glufosinate in the form of a salt.

3. The method as claimed in claim 1, wherein the crop-treatment composition further comprises at least one further agrochemical active ingredient in addition to glufosinate.

4. The method as claimed in claim 3, wherein the further agrochemical active ingredient is a water-soluble salt of a pesticide.

5. (canceled)

6. The method as claimed in claim 1, wherein the crop-treatment composition comprises
a) glufosinate and optionally at least one further agrochemical active ingredient,
b) at least one N alkylglucamide of the formula (I) as claimed in claim 1,
c) at least one polyalkylene glycol ether sulfate salt or polyalkylene glycol ether sulfonate salt,
d) water,
e) optionally at least one cosolvent selected from the group consisting of dihydric and trihydric alcohols, and
f) optionally further surfactants.

7. The method as claimed in claim 1, wherein the crop-treatment composition is present as an in-can variant.

8. The method as claimed in claim 1, wherein the crop-treatment composition is present as a spray mixture.

9. The method for reducing drift during application of a crop-treatment composition, comprising the step of spraying an aqueous spray mixture comprising at least one N-alkylglucamide of the formula (I) as claimed in claim 1, at least glufosinate as agrochemical active ingredient, and optionally further surfactants onto the plants to be treated or the site thereof, wherein the total surfactant content, based on the total amount of aqueous spray mixture, is 0.001 to 0.30% by weight, and wherein the proportion of N-alkylglucamide of the formula (I), based on the total amount of surfactant in the aqueous spray mixture, amounts to 50 to 100% by weight.

10. The method as claimed in claim 9, wherein the crop-treatment composition comprises
a) glufosinate and optionally at least one further agrochemical active ingredient,
b) at least one N-alkylglucamide of the formula (I) as claimed in claim 1,
c) at least one polyalkylene glycol ether sulfate salt or polyalkylene glycol ether sulfonate salt,
d) water,
e) optionally at least one cosolvent selected from the group consisting of dihydric and trihydric alcohols, and
f) optionally further surfactants.

11. A method for preparing an aqueous spray mixture having drift-reducing properties when applied, which comprises diluting a concentrate comprising at least one N-alkylglucamide of the formula (I) 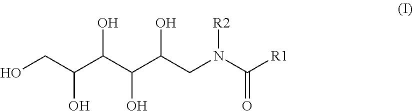
where
R1 is a linear or branched alkyl group having 5 to 9 carbon atoms and
R2 is an alkyl group having 1 to 3 carbon atoms,
at least glufosinate as agrochemical active ingredient, and optionally further surfactants with water to give an aqueous spray mixture, wherein the total surfactant content of the concentrate, based on the total amount of concentrate, is 0.1 to 30% by weight, the proportion of N-alkylglucamide of the formula (I), based on the total amount of surfactant in the concentrate, amounts to 50 to 100% by weight, and wherein the total surfactant content of the aqueous spray mixture, based on the total amount of aqueous spray mixture, is 0.001 to 0.30% by weight, and the proportion of N-alkylglucamide of the formula (I), based on the total amount of surfactant in the aqueous spray mixture, amounts to 50 to 100% by weight.

12. The method as claimed in claim 1, wherein the crop-treatment composition comprises glufosinate in the form of an ammonium salt.

13. The method as claimed in claim 12, wherein the crop-treatment composition further comprises at least one water-soluble salt of dicamba.

14. The method as claimed in claim 12, wherein the crop-treatment composition further comprises at least one water-soluble salt of dicamba, wherein the water-soluble salt of dicamba is selected from the group consisting of dicamba diglycolammonium, dimethylammonium, N,N-bis(3-aminopropyl)methylammonium, dimethylglucammonium, and sodium dicamba.

15. The method as claimed in claim 3, wherein the further agrochemical active ingredient is a water-soluble salt of a herbicide.
